(19) United States
(12) Patent Application Publication
(10) Pub. No.: US 2013/0107505 A1
(43) Pub. Date: May 2, 2013

(54) RAPID CHARGE CAPACITOR LIGHT

(71) Applicant: Charles A. Frazier, Holiday, FL (US)

(72) Inventor: Charles A. Frazier, Holiday, FL (US)

(73) Assignee: TACTICAL ENERGY CORPORATION, Tarpon Springs, FL (US)

(21) Appl. No.: 13/283,414

(22) Filed: Oct. 27, 2011

(51) Int. Cl. F21L 4/08

(52) U.S. Cl. 362/183

(57) ABSTRACT

A rapid charge capacitor light that uses multiple ultracapacitors wired in series with a resistor wired in parallel with each capacitor. The output from these ultracapacitors is connected to a circuit board configured as a constant current source. The constant current source can be operated in steady mode or both steady and strobe modes. This controlled current is fed into one or more LEDs wired in parallel to produce the required intensity of light. The ultracapacitors used in the power pack are hybrids and have an extremely low ESR (equivalent series resistance) which allows the power pack to be recharged rapidly (12-15 seconds). A collimator is incorporated with the light and is configured to focus the emitted light forward.

### FIELD OF THE INVENTION

The invention relates to electronic lights including flashlights that utilize a charging powered circuit in lieu of batteries.

### BACKGROUND OF THE INVENTION

In the last few years, there has been a successful development in electronics of families of practical capacitor devices that possess exceedingly large electrical charge storage capacities. These devices obey all the laws of physics that older designs and components do, but they simply store orders of magnitude greater amounts of charge than previous elements could in the same sized container. This is done with the drawback of being limited to lower than generally expected charging voltage. For the application of operating a light, this poses a relatively minor inconvenience in light of the benefits it enables. It can provide a means of altogether replacing a battery as a prime energy source. This has many benefits that will be elucidated below along with an explanation of the electronics necessary to implement a design of the first fully electronic flashlight.

Typically, lights such as flashlights that use batteries, both disposable and rechargeable, create a number of logistical problems for law enforcement and military users. These problems include maintaining a steady supply of batteries, disposal issues of the hazardous waste materials, length of time needed to recharge conventional rechargeable batteries, the replacement costs associated with traditional and rechargeable batteries, and inventory costs associated with the supply chain, among other problems.

Traditional batteries and disposable battery operated lights/flashlights diminish in brightness as the batteries discharge thereby reducing their usable power. Conventional rechargeable batteries if not fully discharged prior to recharging will build-up a memory which reduces the available storage capacity of the battery over time.

In addition, traditional flashlights use reflectors to focus their light into a cone shape. These reflectors scatter the light and waste much of the available lumens. An object of the present invention is to incorporate a collimator to focus 100% of the produced light forward without producing the “dark spot” in the center which is typical with lights using reflectors.

### SUMMARY OF THE INVENTION

All of the aforementioned problems can be solved by replacing traditional and rechargeable batteries with ultracapacitors, also known as supercapacitors. A light equipped with ultracapacitors rather than batteries can be recharged in fifteen seconds instead of two or three hours. Ultracapacitors can be recharged over 500,000 times as compared with the 20-30 times of rechargeable batteries. Ultracapacitors do not suffer from memory build-up like rechargeable batteries. Lights equipped with ultracapacitors are much lighter than those equipped with traditional batteries.

Lights equipped with ultracapacitors do require the use of a constant current source to allow the ultracapacitors to discharge at a controlled rate to prevent the Light Emitting Diodes (LEDs) from being burnt out from too much current.

In an example of the rapid charge capacitor light, the light uses several 2.3 volt ultracapacitors wired in series with a 1 megohm resistor wired in parallel with each capacitor. The output from these ultracapacitors is connected to a circuit board configured as a constant current source. The constant current source can be operated in steady mode or both steady and strobe modes. This controlled current is fed into one or more LEDs wired in parallel to produce the required intensity of light. The ultracapacitors used in the power pack are hybrids and have an extremely low ESR (equivalent series resistance) which allows the power pack to be recharged rapidly (12-15 seconds).

Since the light emitting element is preferably a very bright white LED that is inherently a current operated device, its performance is more suited to being powered by a current source (like a capacitor). This compatibility is enhanced by an internal constant current regulation circuit that keeps the light at the same, constant brightness during use until the charge is depleted. It then shuts down immediately. Rapid recharge makes this light virtually uninterruptable in normal use.

The present invention light will operate in cold temperatures as well as in more moderate ambients. The caps are specified down to −40 degrees C. and up to 85 degrees C. (−40F. to +185F.). It should be noted that batteries lose their available energy at the rate of 50% per 10 degrees C. Someone using a battery operated light will have only 1/16 the power at −40 degrees C. as he has at the freezing point. A light that could operate for an hour is cut down to about 4 minutes. Anecdotally, an opposite effect has been noticed with a capacitor powered light. To summarize the above in terms of the hereinafter claims of the present invention, the invention is a rapid charge capacitor light comprising a charging control circuit, one or more LEDs,

the one or more (LEDs are in electronic communication with the charging control circuit, the charging control circuit comprises multiple charge storage components bridged across corresponding associated resistors, the associated resistors serve to evenly distribute voltages across the charge storage components in a charge storage string, a power output from the charge storage string is in electrical communication with a circuitry of the light, and the circuitry of the light comprises means for operating the light in steady state mode or for selectively operating the light in a steady state mode and a strobe mode. The multiple charge storing components are ultracapacitors electrically connected in series. The invention further comprises a collimator that includes means for focusing forward a light emitted from the LEDs. The means for focusing forward the light emitted from the LEDs comprises a pocket molded into a rear portion of the collimator where the molded pocket is in front of the LEDs. The pocket has a generally semi-circular cross-sectional shape. In one embodiment, the one or more LEDs is a quad diode chip. The circuitry of the light includes a shift register for controlling the functions of the light.

### BRIEF DESCRIPTION OF THE DRAWINGS

In the accompanying drawings:

FIG. 1 is an example of a wiring schematic for a capacitor power pack circuit;

FIGS. 2-3 depict an example of a circuit for a light that is capable of operating in both a steady mode and a strobe mode;

FIG. 4 depicts an example of a circuit for an embodiment of the present inventive flashlight capable of operating in a steady mode function; and

FIG. 5 is a conceptual depiction of the use of a collimator in the present invention.

### DETAILED DESCRIPTION OF THE INVENTION

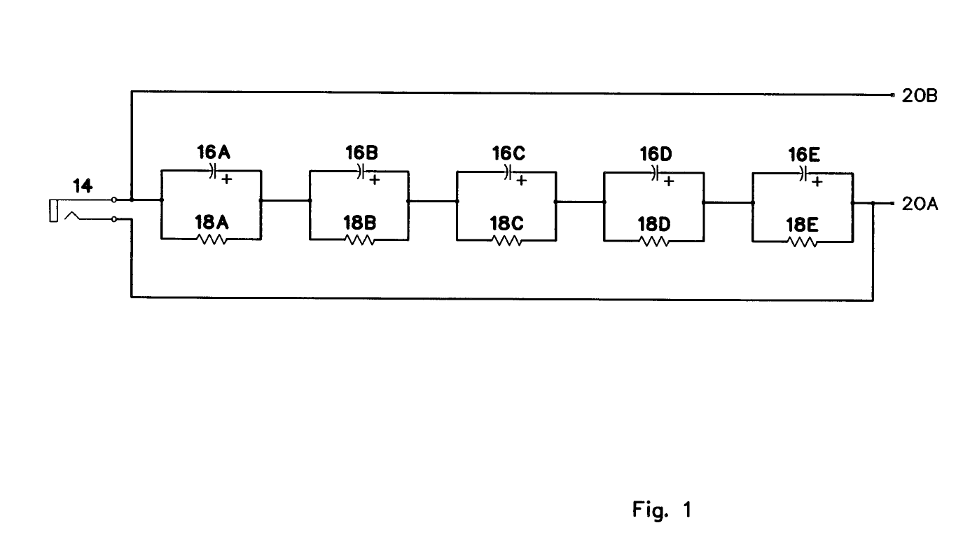

Referring now to the drawings, FIGS. 1-5, depict an example of a typical schematic for a rapid charge capacitor light or flashlight. The generic term “light” used hereinafter is considered synonymous with a flashlight or any light that incorporates the inventive circuitry. Generally, an example of a schematic depiction of the present invention is as depicted in FIGS. 1-5.

FIG. 1 depicts a capacitor power pack circuit. The power pack uses several ultracapacitors wired in series. Each ultracapacitor has a 1 megohm resistor wired in parallel to insure an even charge along the pack. In FIG. 1, resistors 18A through 18E are wired in parallel with untracapacitors 16A through 16E. These resistor/capacitor networks are then wired in series to form the power pack.

Resistor/capacitor networks 16A/18A are then wired to a DC power connector 14 at one end of the power pack, and 20A and 20B are the positive and negative outputs respectively at the other end of the power pack. The power pack shown in FIG. 1 provides 11.5 volts of DC power to the flashlight circuit-boards although a higher or lower voltage can by supplied by using more or less resistor/capacitor networks in the power pack. The power pack is charged through connector 14 using a 12 volt or 120 volt power supply (not shown), which is regulated to a 11.4 volt DC for recharging a power pack for flashlights or 13.6 volts for recharging power packs for flood lights.

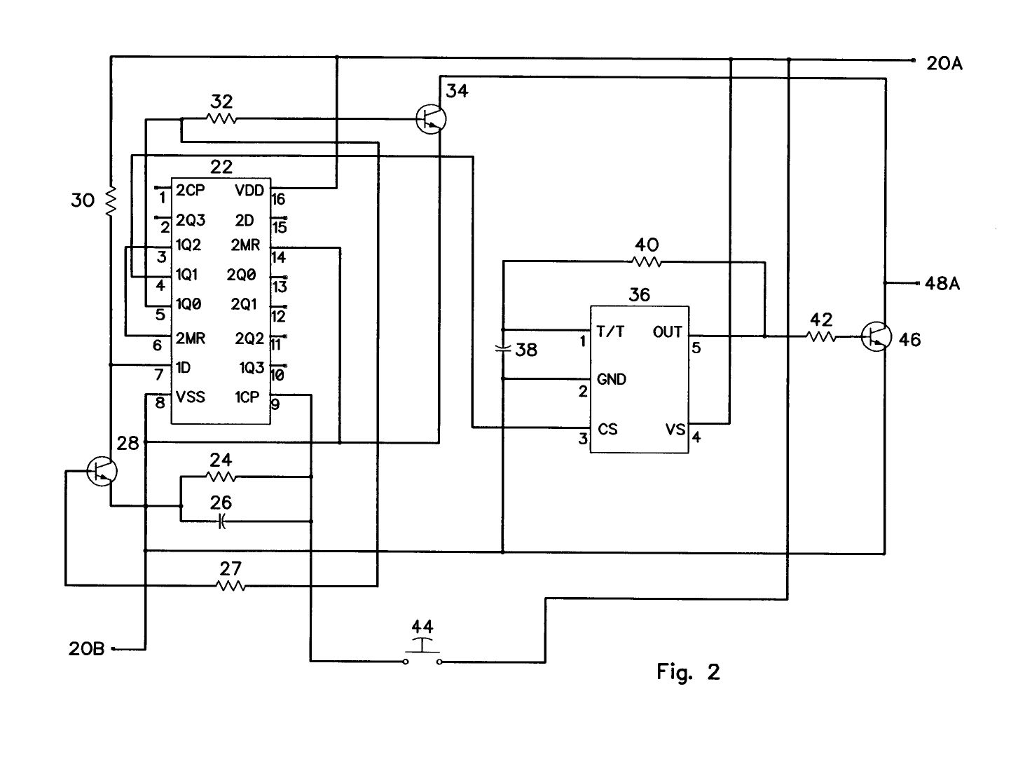

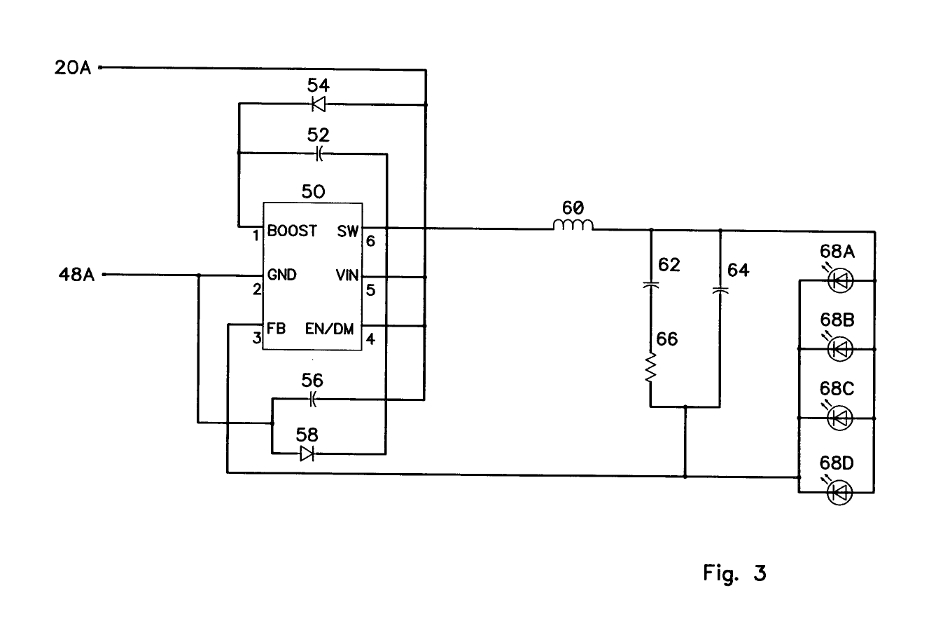

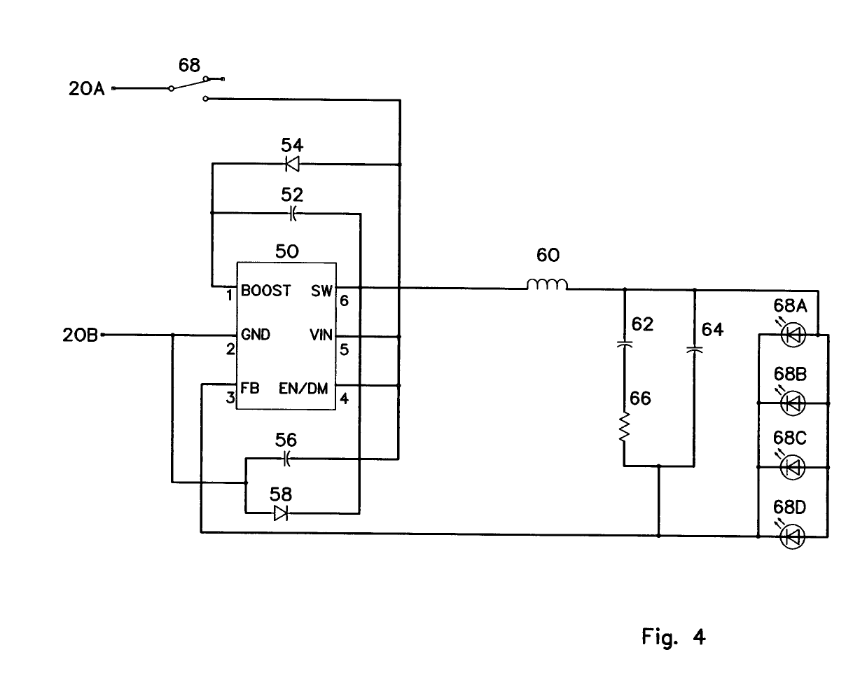

The circuit boards depicted in FIGS. 2 and 3 comprise the circuit board of a flashlight with both steady and strobe modes, whereas FIG. 4 shows the circuit board for a light with steady mode only. The circuit in FIG. 2 uses a shift register (22), such as the HEF4015BT manufactured by NXP Semiconductor, to function as a latch for the momentary contact switch (44) and to toggle between steady and strobe modes on flashlights equipped with a strobe mode. Components 22 through 32 comprise the latch/toggle portion of the circuit.

The output from pin 4 of IC 22 turns IC 36 on when the momentary contact switch is pressed the first time. When the momentary contact switch is pressed the second time, pin 4 of Integrated Circuit IC 22 is disabled turning off IC 36; and pin 5 of IC 22 is activated turning on transistor 34. When the momentary switch is pressed a third time the shift register resets turning the flashlight off.

IC 36, along with components 38 and 40, comprise the oscillator circuit for the strobe function of the flashlight. When IC 36 is turned on, the output from pin 5 of IC 36 feeds through resistor 42 biasing transistor 46 on, and providing a pulsating path from point 48A to ground turning on the constant current circuit of FIG. 3, thus causing the light's LEDs 68A through 68D to strobe at a frequency set by IC 36. When transistor 34 is turned on, it provides a path from point 48A to ground 20B turning on the constant current circuit of FIG. 3 causing the light's LEDs to turn on in a steady mode.

FIG. 3 illustrates the constant current source which is comprised of IC 50 and components 52 through 66. When pin 2 of IC 50 is sourced to ground through transistor 46, the constant current is turned on and off alternately at the frequency of IC 36 in FIG. 2. When pin 2 of IC 50 is sourced to ground through transistor 34 of FIG. 2, the constant current source turns on and stays on until transistor 34 is switched off by pin 5 of IC 22.

FIG. 4 shows the circuit for a light with steady mode only function. In this circuit, the ground of IC 50 (pin 2) is connected to the ground of the power pack (20B in FIG. 1). The single pole-double throw switch 68 in FIG. 4 is connected to the positive of the power pack (20A in FIG. 1). When the switch is turned on, the constant current source supplies a regulated current to the light's LEDs. The amount of regulated current is determined by the values of the peripheral components selected for IC 50.

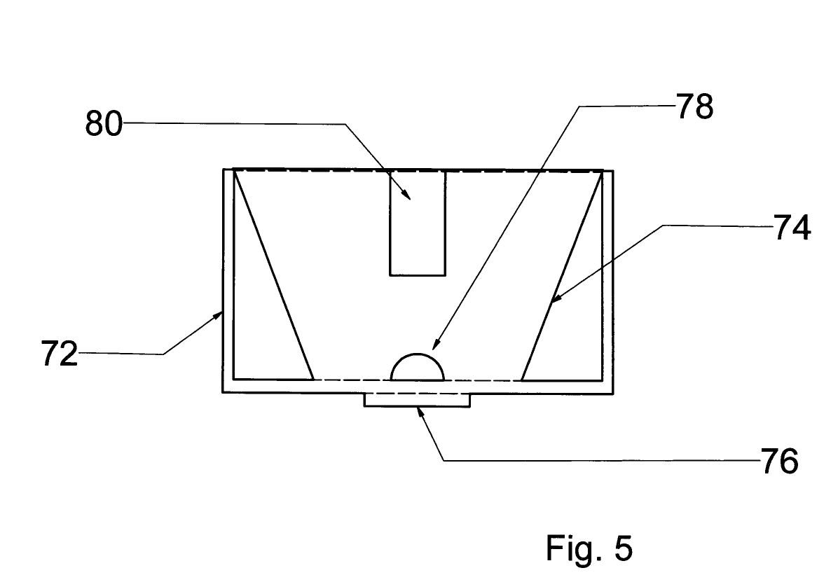

FIG. 5 shows a collimator (74) mounted in housing (72). A pocket molded into the rear of the collimator (78) allows the lens from the diodes, or as in FIG. 5, a quad diode such as the Cree MC-E quad diode chip (76) to focus all of the available light forward. A second pocket molded into the front of the collimator (80) allows the light from the tip of the LED to be directed forward, thereby elimination the dark spot associated with conventional reflectors.

Some of the key functional features or characteristics of the present invention include: each ultracapacitor is shunted with a resistor to insure that each capacitor in the power pack charges to the same voltage, the use of the ultracapacitors in series instead of in parallel, the design of the circuits boards, the use of the collimator, the use of a shift register to control the functions of the light, and the ultracapacitors used in the power pack are hybrids and have an extremely low ESR (Equivalent Series Resistance).

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A rapid charge capacitor light comprising:
a charging control circuit;
one or more Light Emitting Diodes (LEDs);
the one or more Light Emitting Diodes (LEDs) being in electronic communication with the charging control circuit;
the charging control circuit comprising multiple charge storage components bridged across corresponding associated resistors, the associated resistors serving to evenly distribute voltages across the charge storage components in a charge storage string;
a power output from the charge storage string is in electrical communication with a circuitry of the light; and
the circuitry of the light comprising means for operating the light in steady state mode or for selectively operating the light in a steady state mode and a strobe mode,
wherein the multiple charge storing components are ultracapacitors electrically connected in series.

2. The light according to claim 1, further comprising:
a collimator, the collimator further comprising means for focusing forward a light emitted from the one or more LEDs.

3. The light according to claim 2, wherein the means for focusing forward the light emitted from the one or more LEDs comprises a pocket molded into a rear portion portion of the collimator, the molded pocket being in front of the one or more LEDs.

4. The light according to claim 3, wherein the pocket has a generally semi-circular cross-sectional shape.

5. The light according to claim 1, wherein the one or more LEDs is a quad diode chip.

6. The light according to claim 1, wherein the circuitry of the light includes a shift register for controlling the functions of the light.
